(19) United States
(12) Patent Application Publication
(10) Pub. No.: US 2004/0231223 A1
(43) Pub. Date: Nov. 25, 2004

(54) Amplified fishing rod handle

(75) Inventor: Steven W. Vogts, West Bend, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(73) Assignee: Frabill, Inc., Jackson, WI (US)

(21) Appl. No.: 10/808,773

(22) Filed: Mar. 25, 2004

Related U.S. Application Data
(60) Provisional application No. 60/471,503, filed on May 19, 2003.

(51) Int. Cl. A01K 75/02

(52) U.S. Cl. 43/23

(57) ABSTRACT

A hollow tubular handle houses the proximal end of a fishing rod blank. A plurality of vibration disks are disposed about the proximal end of the rod blank and encircle the blank. Each disk is a substantially flat planar member having a centrally located aperture defined in it for centering the disk on the blank. Each disk may have a plurality of prong-like members extending outwardly from the central portion of the disk. The outermost portion of each prong-like member is urged and seats against the inner surface of the tubular handle. Use of such disks results in an effective transmission of the vibrations that propagate through the rod blank to the angler's hand. The use of a thin-walled tubular handle member serves as a resonating chamber to further amplify the transmitted vibrations and further increase sensitivity of the rod handle.

This application claims the benefit and priority of U.S. Provisional Pat. No. 60/471,503 filed May 19, 2003.

### FIELD OF THE INVENTION

This invention relates generally to fishing rods. More particularly, it relates to a fishing rod handle that has increased sensitivity to fishing line disturbance.

### BACKGROUND OF THE INVENTION

Fishing has evolved from being a means of human survival in ancient times to being a competitive and recreational sport in modern times. A fishing line, hook and bait have always been, and still are, the absolutely necessary elements for attempting a successful fishing outing. At some point in fishing history, the advent of the fishing pole or fishing rod greatly enhanced the ability of the fisherman to cast a hook with bait, or a lure, substantial distances and with greater accuracy. Traditional fishing rod design and construction relies specifically on lightweight designs that utilize graphite blanks. In this fashion, the fishing rod has also evolved to become a sensitive extension of the fishing line to which it is attached. That is, the graphite blanks are known to transfer vibrations in the line to the rod handle. Most modern fishing rods feature “blank through” construction wherein the rod blank is inserted through a cork or foam handle that is glued to and surrounds the rod blank. Blank through handle design and construction is often touted by the fishing rod industry as providing a stronger and more sensitive rod. In fact, graphite blank through rods are the most sought after fishing rods because of their lightweight and higher modulus construction which conducts or “telegraphs” vibration better than fiberglass or other fiber materials. This graphite sensitivity is recognized as a standard in the fishing rod industry on upper scale rod products and totally dominates the market as the preferred rod blank material.

In the experience of this inventor, however, almost all manufacturers of such rods surround the ultra sensitive, and expensive, graphite rod blanks with solid foam or cork handles. Both cork and the various types of foam that are used this way are known dampening agents for vibration. For example, cork and foam panels are known to line sound recording studios and the like, all for the purpose of dampening sound vibrations. Accordingly, and to the same effect, cork and foam used as rod handle material tend to dampen and decrease the amount of vibration that is transferred down the rod blank and to the angler's hands. In this fashion, these materials serve only to de-sensitize the rod blank, leaving the angler with less tactile feel for what is going on under the water and at the other end of his or her fishing rod. In the view of this inventor, there is a direct relationship between the angler's ability to feel the slightest strike or change in line tension and the angler's ability to catch more fish.

There have been prior attempts to enhance that sensitivity, primarily by providing the angler with direct tactile contact with a portion of the rod blank that passes through or is contained within the handle. Such attempts are disclosed in U.S. Pat. No. 4,644,680 issued to Dawson and in U.S. Pat. No. 4,848,022 issued to Ozeki et al.

The patent to Dawson discloses and claims a rod-like transmitter member that extends into a hollow portion of the rod blank. A portion of the transmitter member is associated with the rod handle so that a user can have a portion of his or her hand in direct contact with the transmitter member. The patent to Ozeki et al. discloses and claims a fishing rod wherein the rod blank itself passes through the handle. In the experience of this inventor, such devices have not significantly increased the sensitivity of the rod blank. Enough support structure exists in the handle to similarly dampen the vibrations that pass to this proximal portion of the rod blank.

Accordingly, it is an object of the present invention to provide a new and useful fishing rod handle that provides greater sensitivity and increased “feel” for the angler so that he or she can detect subtle line disturbance and strikes from fish. It is another object of the present invention to provide such a rod handle that provides a non-dampening tubular handle member that provides direct contact with the angler's hand and that serves as a resonating chamber to further amplify vibrations that propagate through the rod blank to the outer surface of the handle member. It is still another object of the present invention to provide a plurality of vibration transferring members disposed between the rod blank of the fishing rod to the handle member. It is yet another object of the present invention to provide such a rod handle that is lightweight and able to be made from a wide variety of materials, the lightweight nature of the rod handle further enhancing the vibration transfer within the device. It is still another object of the present invention to provide such a rod handle that is relatively simple in construction and that can be made from a minimal number of elements.

### SUMMARY OF THE INVENTION

The amplifier fishing rod handle of the present invention has obtained these objects. It provides for a hollow tubular handle into which extends the proximal end of a fishing rod blank. A plurality of vibration disks are disposed about the proximal end of the fishing rod blank and encircle the blank. Each disk is a substantially flat planar member having a centrally located aperture defined in it for centering the disk on the blank. The disks are spaced along the blank. In the preferred embodiment, each disk has a plurality of prong-like members extending outwardly from the central portion of the disk. The outermost portion of each prong-like member is urged and seats against the inner surface of the tubular handle. In this fashion, the proximal end of the rod blank is effectively suspended inside the hollow tubular handle by highly conductive vibration transferring disks. Use of such disks results in an effective transmission of the vibrations that propagate through the rod blank to the angler's hand. The use of a thin-walled tubular handle member serves as a resonating chamber to amplify the transmitted vibrations and further increase sensitivity of the rod handle.

The foregoing and other features of the present invention will be apparent from the detailed description that follows.

### BRIEF DESCRIPTION OF THE DRAWINGS

FIG. 1 is a cross sectional side elevational view of an amplifier fishing rod handle constructed in accordance with the present invention.

FIG. 2 is a front view of a vibration disk used in the handle shown in FIG. 1 and showing the disk fins as they would extend outwardly from the disk center prior to being bent.

FIG. 3 is an enlarged front view of the vibration disk shown in FIG. 2 and showing the disk fins being bent.

FIG. 4 is a side elevational view of the vibration disk shown in FIGS. 2 and 3.

FIG. 5 is a side and top perspective view of the vibration disk shown in FIGS. 2 through 4.

### DETAILED DESCRIPTION

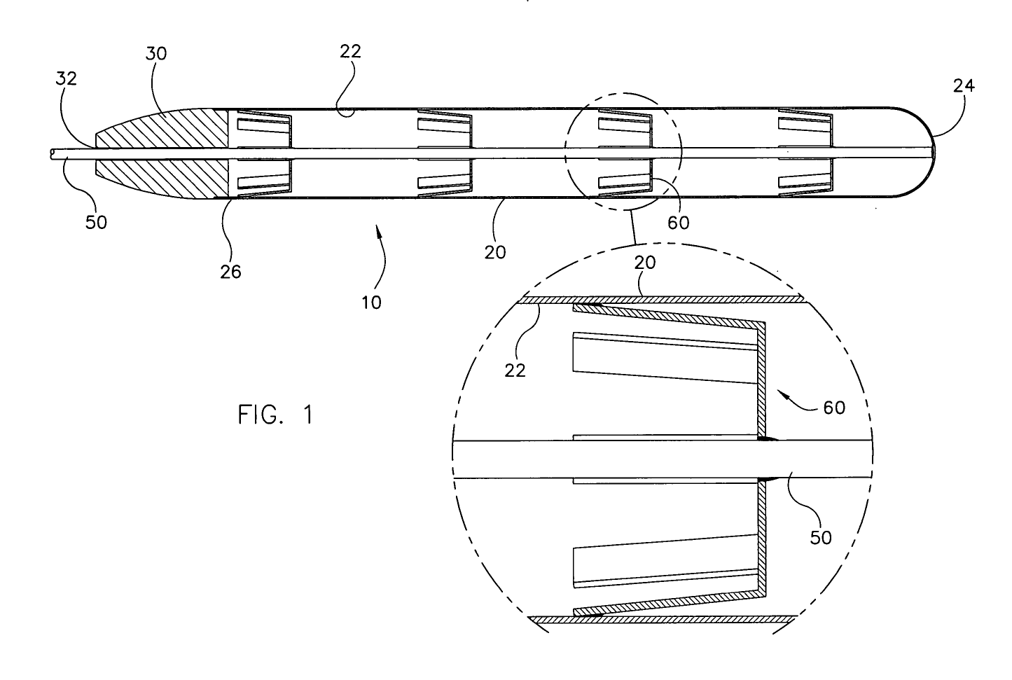

Referring now to the drawings in detail wherein like numbers represent like elements throughout, FIG. 1 illustrates a perspective view of one embodiment of the amplifier fishing rod handle, generally identified 10, constructed in accordance with the present invention. As shown, the handle 10 includes a handle tube 20, a nose cone 30, a blank 40 and a plurality of vibration disks 50.

The handle tube 20 includes a first tube end 22 and a second tube end 24. As shown, the first tube end 22 is open and the second tube end 24 is closed. The handle tube 20 includes a tube hollow or void 26 which is defined by the inner surface 28 of the handle tube 20. The handle tube 20 also includes an outer surface 29. Insertable within the first tube end 22 is a nose cone 30. The nose cone 30 is tapered from one end 32 that is roughly the diameter of the handle tube 20 to a second end 34 that is substantially smaller in diameter. Axially defined within the nose cone 30 is a longitudinally extending nose cone aperture 32. A fishing rod blank 40 is also provided. The proximal portion 42 of the rod blank 40 extends through the nose cone aperture 32 and into the void 26 of the tube 20.

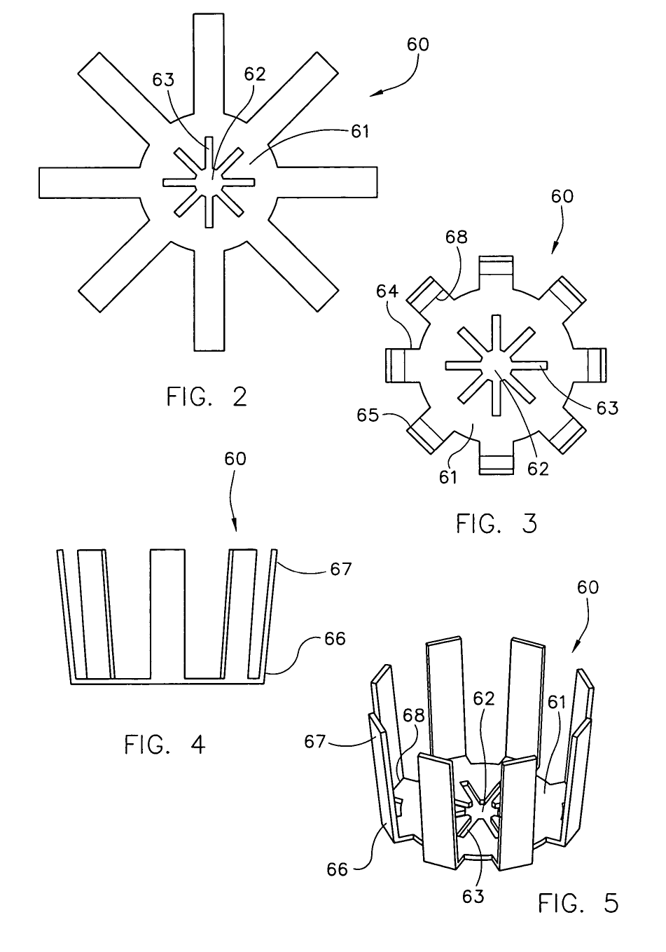

Spaced along the proximal portion 42 of the rod blank 40 is a plurality of vibration disks 50. Referring now to FIGS. 2 and 3, it will be seen that each vibration disk 50 includes a central disk portion 51 and a central disk aperture 52. In the preferred embodiment, the central disk aperture 52 is formed in a somewhat star-shaped pattern wherein a plurality of outwardly extending central aperture voids 53 alternate with a plurality of inwardly extending prongs 54. The central aperture 52 and the central aperture voids 53 allow the proximal portion 42 of the rod blank 40 to pass through the central portion 51 of the disk 50. The inwardly extending prongs 54 allow the disk 50 to firmly attach to a portion of the rod blank 40. Extending outwardly from the central portion 51 of the disk 50 is a plurality of outwardly extending prongs 55. Each outwardly extending prong 55 includes a proximal prong portion 56 that is closest to the central portion 51 of the disk 50 and a distal prong portion 57 that is farthest from the central portion 51. The proximal prong portion 56 and the distal prong portion 57 of each disk 50 intersect at a prong bend 58. See FIGS. 4 and 5. In the preferred embodiment, each outwardly extending prong 55 is bent in the same direction and to the same degree as the others. When placed on the rod blank 40, each prong 55 will be bent away from the proximal end 42 of the rod blank 40. In this fashion, the proximal end 42 of the rod blank 40 will allow insertion of the rod blank 40 and disks 50 into the handle tube hollow 26, with outward pressure being exerted on the inner tube surface 26 by each of the outwardly extending prongs 55 and the distal prong portions 57 in particular.

In application, the proximal portion 42 of the rod blank 40 is inserted through the vibration disks 50. The disks 50 are evenly spaced as such is desired or required and then may be cemented to the rod blank 40. In this fashion, the disks 50 provide structural support to the outer handle tube 20 once the blank 20 and disks 50 are inserted into the tube 20 and also provide an even distribution for channeling vibrations to the entire outer surface 29 of the tube 20. Each disk 50 is retained in a given position relative to the other disks 50 that may be used. Obviously, the number of disks 50 used can vary depending on the length of the handle tube 20. An ice fishing handle that uses the present invention would likely be somewhat shorter than its open water counterpart. The precise number of disks 50 is not, however, a limitation of this invention. Once the disks 50 are attached to the rod blank 40, the blank 40 and disk 50 assembly is inserted into the void 26 within the handle tube 20. The rod blank 40 runs through the axial center of the tube 20 to the second tube end 24. As previously alluded to, the disks 50 are designed to spread outwardly and be urged against the inner wall 28 of the tube 20. This is a pressure contact fit. Additional cement may be used to secure the location of the distal prong portions 57 in relation to the inner wall 28. The nose cone 30 is then slid over the blank 40 and glued into the first open tube end 22 to complete the construction.

By way of further explanation, the handle tube 20 and the vibration disks 50 are made of aluminum in the preferred embodiment. The handle tube 20 includes a thin wall design and can be of any length. Accordingly, the tube 20 could be made from a wide variety of lightweight materials such as plastic polymers, graphite or lightweight metals and alloys without deviating from the scope of the present invention. Aluminum is preferred because of its weight and conductivity of vibration.

It is also to be understood that the handle tube 20 need not be perfectly straight. A change in the profile of the outer surface 29 could be utilized, also without deviating from the scope of this invention. The fundamental principle here is the tubular hollow nature of the handle 20 with the rod blank 40 in contact with the inner walls 28 of the handle 20 through a series of vibration disk supports 50 that bridge the contact between the rod blank 40 and the inner handle walls 28. The hollow nature of the handle 20 also serves to provide a resonating chamber within which rod blank 40 vibrations are further amplified for increased sensitivity of the device 10.

As mentioned, the disks 50 of the preferred embodiment are made of aluminum. The precise material used is not a limitation of this invention. The precise shape of the disks 50 is not a limitation either. Accordingly, disks 50 could be made of other materials, including any of those of which the handle 20 is made, and may be configured into a wide variety of different shapes, including solid disks. If made in accordance with the preferred embodiment, burrs can form on the perimeter of the disks 50 during the machining of the vibration disks 50. In this situation, it is preferable to locate the disks 50 within the handle tube 20 such that any burrs on the distal prong portions 67 face outwardly to contact the inner surface 28 of the handle tube 20. This enhances the grip between those two elements.

The nose cone 30 may be made from ethylene vinyl acetate, plastic polymers, cork, graphite, plastic or other materials. The nose cone 30 offers a cushioned support for that portion of the rod blank 40 that passes through the nose cone aperture 32. It also serves as a centering device of the rod blank 40 relative to the hollow 26 of the handle tube 20.

As previously alluded to, the hollow nature of the handle tube 20 allows for vibrations passing through the rod blank 40 and through the disks 50 to resonate within a resonance chamber. This chamber is defined by the inner surface 26 of the handle tube 20 and a portion of the nosecone 30. Within this resonance chamber, vibrations propagating through the disks 50 will be amplified for overall increased sensitivity of the device 10.

Based upon the foregoing, it will be seen that there has been provided a new and useful fishing rod handle that provides greater sensitivity and increased “feel” for the angler so that he or she can detect subtle line disturbance and strikes from fish; that provides a non-dampening tubular handle member for direct vibration transfer to the angler's hand and that serves as a resonating chamber to further amplify vibrations that propagate through the rod blank to the outer surface of the handle member; that provides a plurality of vibration transferring members disposed between the rod blank of the fishing rod to the handle member; is lightweight and able to be made from a wide variety of materials, the lightweight nature of the rod handle further enhancing the vibration transfer within the device; and is relatively simple in construction and can be made from a minimal number of elements.

The principles of this invention having been fully explained in connection with the foregoing, I hereby claim as my invention:

1. A fishing rod handle which comprises a handle member, said handle member having an internal hollow and an external surface,
a fishing rod blank, a portion of said fishing rod blank being insertable within said handle member hollow, and
a plurality of vibration disks, each said disk being attachable to that portion of the fishing rod blank that is inserted within said hollow handle member,
wherein vibrations emanating from the rod blank are transferred through the vibration disks and through the handle member to the external surface of the handle member.

2. The fishing rod handle of claim 1 wherein the internal hollow of the handle member comprises a linear aperture defined within the handle member.

3. The fishing rod handle of claim 2 wherein the linear aperture has an internal cylindrical wall and the external surface of the handle member is parallel linear with that cylindrical wall.

4. The fishing rod handle of claim 1 wherein the handle member hollow has a first open end and a second closed end, and including a nose cone, said nose cone having an axially disposed aperture for receiving a portion of the rod blank therewithin and said nose cone being insertable within the first open end of the handle member hollow.

5. The fishing rod handle of claim 1 wherein each vibration disk comprises a flat circular disk member having a central aperture for receiving a portion of the rod blank therewithin.

6. The fishing rod handle of claim 5 wherein each vibration disk further includes a plurality of prongs extending outwardly from the flat disk member.

7. The fishing rod handle of claim 6 wherein each vibration disk has a first disk face and each of the plurality of outwardly extending prongs is bent toward the first disk face.

8. The fishing rod handle of claim 7 wherein the vibration disks that are attached to the disk blank are attached such that the prongs of each disk are bent in the same direction.

9. The fishing rod handle of claim 1 wherein the rod blank, the plurality of vibration disks, and the handle member is each constructed of a vibration conductive material.

10. The fishing rod handle of claim 9 wherein the rod blank is constructed of a graphite material.

11. The fishing rod handle of claim 9 wherein the handle member is constructed of a metal material.

12. The fishing rod handle of claim 9 wherein each of the plurality of vibration disks is constructed of a metal material.

13. A vibration amplifying fishing rod handle which comprises
a longitudinally extending handle member, said handle member having an external surface and a linear hollow defined within it, said linear hollow being defined by an internal surface,
a longitudinally extending fishing rod blank, a portion of said fishing rod blank being insertable within the linear hollow of said handle member, and
a plurality of vibration members, each said member being attachable to that portion of the fishing rod blank that is inserted within said hollow handle member,
wherein vibrations emanating from the rod blank are transferred through the vibration members and through the handle member to the external surface of the handle member.

14. The fishing rod handle of claim 13 wherein the handle member hollow has a first open end and a second closed end, and including a nose cone, said nose cone having an axially disposed aperture for receiving a portion of the rod blank therewithin and said nose cone being insertable within the first open end of the handle member hollow.

15. The fishing rod handle of claim 13 wherein each vibration member comprises a flat circular disk member having a central aperture for receiving a portion of the rod blank therethrough.

16. The fishing rod handle of claim 15 wherein each vibration member further includes a plurality of prongs extending outwardly from the flat disk member.

17. The fishing rod handle of claim 16 wherein each vibration member has a first disk face and each of the plurality of outwardly extending prongs is bent toward the first disk face.

18. The fishing rod handle of claim 17 wherein the vibration members that are attached to the disk blank are attached such that the prongs of each disk are bent in the same direction.

19. The fishing rod handle of claim 13 wherein the rod blank, the plurality of vibration members, and the handle member is each constructed of a vibration conductive material.

20. The fishing rod handle of claim 19 wherein the rod blank is constructed of a graphite material.

21. The fishing rod handle of claim 19 wherein the handle member is constructed of a metal material.

22. The fishing rod handle of claim 19 wherein each of the vibration members is constructed of a metal material.
